(19) United States
(12) Patent Application Publication
(10) Pub. No.: US 2017/0185676 A1
(43) Pub. Date: Jun. 29, 2017

(54) SYSTEM AND METHOD FOR PROFILING A USER BASED ON VISUAL CONTENT

(71) Applicant: Picsoneye Segmentation Innovations Ltd, London (GB)

(72) Inventor: Nadav TAL-ISRAEL, Petah-Tikva (IL)

(21) Appl. No.: 15/263,647

(22) Filed: Sep. 13, 2016

Related U.S. Application Data
(60) Provisional application No. 62/272,106, filed on Dec. 29, 2015.

(51) Int. Cl. G06F 17/30; G06N 5/04

(52) U.S. Cl. CPC G06F 17/30828; G06F 17/30247; G06F 17/30781; G06F 17/3082; G06N 5/04; H04L 67/306

(57) ABSTRACT

A system and method for profiling a user may generate abstract data based on features identified in visual content, the visual content stored in a computing device of a user, and may generate a profile of the user based on the abstract data and based on metadata related to the visual content. A profile may be used to perform at least one of: generating a prediction related to a behavior of the user and selecting content to be presented to the user.

### CROSS-REFERENCE TO RELATED APPLICATIONS

This application claims the benefit of U.S. Provisional Patent Application No. 62/272,106, entitled “System and Method for Profiling a User based on Visual Content”, filed on Dec. 29, 2015, which is incorporated in its entirety herein by reference.

### FIELD OF THE INVENTION

The present invention relates generally to profiling a user based on visual content and to metadata related to the visual content. More specifically, the present invention relates to using visual content of a user in order to characterize, classify and/or profile the user.

### BACKGROUND OF THE INVENTION

Systems and methods for providing content to users based on personalization or profiling are known. Personalization may be used in order to provide specific content or services to a specific individual, rather than to a group of individuals. For example, web based personalization uses browsing history, cookies, and behavioral or contextual data in order to identify and personalize content to a user. For example, data collected and generated by web based personalization or profiling may be used in order to select advertisements presented by a web browser.

### SUMMARY OF THE INVENTION

An embodiment may use a model received from a server to identify visual features in visual content stored in a computing device operated by a user and to generate a set of summary or abstract data based on the identified features. An embodiment for profiling a user may generate abstract data based on features identified in visual content, the visual content stored in a computing device of a user, and may generate a profile of the user based on the abstract data and based on metadata related to the visual content. A profile may be used to for example perform at least one of: generating a prediction related to a behavior of the user and selecting content to be presented to the user.

An embodiment may respond to a query based on at least one of: a profile of a user and abstract data and metadata related to visual content. A response to a query may be based on relating a user profile to a plurality of profiles of known users. An embodiment may predict, based on a user profile, whether or not a user will positively respond to a presentation of a specific content. Abstract data may be generated based on a model received from a server wherein the model may be dynamically updated by the server. Abstract data may include for example a digital representation of visual features identified in the visual content, a frequency of appearance of a visual feature in the visual content, geo-location information related to the visual content, time information, and information related to a source of a visual content. A user may be classified based on relating a profile of the user to a plurality of profiles of known users and a response to a query may be generated based on the classification of the user.

An embodiment may generate a profile for the user and/or a prediction related to a behavior of the user based on for example the abstract data and metadata related to the visual content. An embodiment may respond to a query based on at least one of: the abstract data and the metadata.

An embodiment may store at least some of the abstract data in a vector and may send the vector to a server. An embodiment may receive a query and may generate a response to the query based on relating the vector to a reference vector. A reference vector may be generated based on extracting visual features from visual content of a plurality of users.

A model may be dynamically updated, in a computing device of a user, by a server. A model may include a set of filters usable for extracting visual features from visual content in a computing device of a user. An embodiment may reduce the size of a model by at least one of: quantization of weights in a kernel of a filter matrix, zeroing of selected values in a kernel of a filter matrix, and using sparse technique to store weights in a kernel of a filter matrix.

Abstract data generated by an embodiment may include for example a digital representation of visual features identified in visual content, a frequency of appearance of a visual feature in visual content, geo-location information related to visual content, time information, and information related to a source of visual content. An embodiment may classify a user based on relating a vector of the user to a plurality of vectors related to a respective plurality of users and may generate a response to a query based on the classification of the user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is an overview of a system according to illustrative embodiments of the present invention;

FIG. 2 shows high level block diagram of an exemplary computing device according to illustrative embodiments of the present invention;

FIG. 3 shows an exemplary screenshot according to illustrative embodiments of the present invention;

FIG. 4 shows a flowchart of a method according to illustrative embodiments of the present invention; and

FIG. 5 shows an exemplary vector and an exemplary profile according to illustrative embodiments of the present invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

A system and method according to some embodiments of the invention may include profiling a user based on visual content, e.g., visual content such as pictures, images video streams or clips, movies, etc. stored in the user's device. A system and method according to some embodiments of the invention may include characterizing, classifying and/or profiling a user based on visual content and based on metadata related to the visual content. A system and method according to some embodiments of the invention may include predicting an action of a user based on summary or abstract features extracted from visual content. For example, as further described herein, based on a profile and/or based on a vector of abstract features or abstract data elements, a system and method according to some embodiments of the invention may predict whether or not a user will buy a specific product or service, or whether or not a user will positively respond to a presentation of specific content etc.

A feature as referred to herein may be or may be identified based on, any digital information in visual content such as an image or video clip. For example, a feature may be an object identified in an image (e.g., a spoon or house) or it may be a human or a pet. A feature may be, or may be identified or determined based on, a scene (e.g., a sunset, a beach or a forest). A feature may be, or may be identified based on, a circumstance, e.g., a party, a funeral and the like. Thus a feature may be an overall description of an image or content, e.g., that the image depicts a party, a wedding, a marathon, etc. A feature may be a set of one or more imaging parameter values, e.g., a light intensity in an image, a hue, color or other values included in a digital image as known in the art may be, or may be treated as, features as described herein. Visual content as referred to herein may be, or may include for example, digital images or pictures, digital video clips or content and/or any other digital information, e.g., in the form of files stored in a computing device as known in the art.

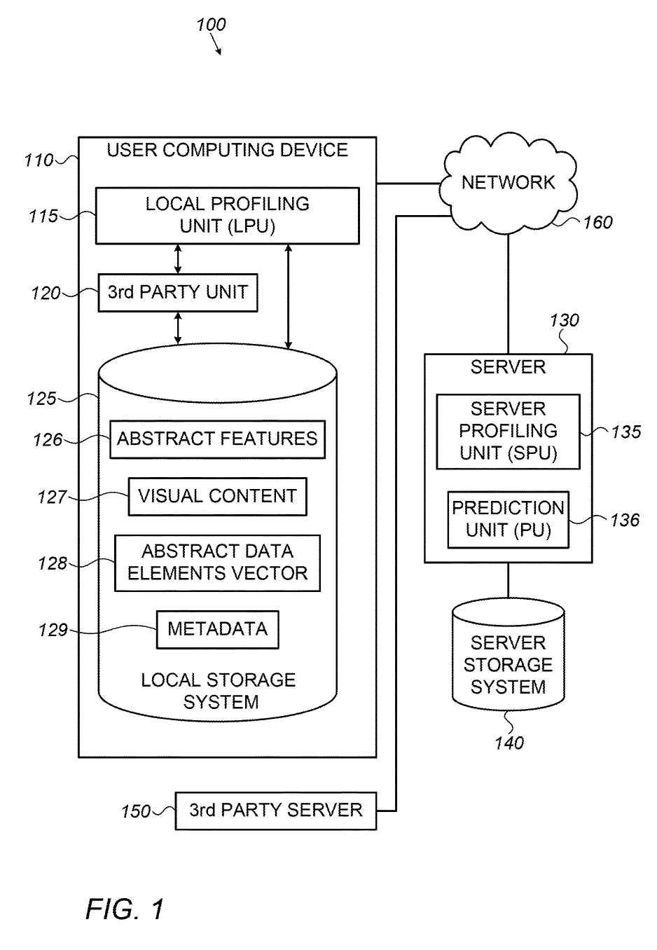

Reference is made to FIG. 1, showing a high level block diagram of an exemplary system 100 according to some embodiments of the invention. As shown, a system may include a user computing device 110 that may include a local profiling unit (LPU) 115, a 3^{rd} party unit, module, or application 120, and a local storage system 125. As further shown, local storage system 125 may include abstract features 126, visual content 127, abstract data elements vector 128 (e.g., a one-dimensional matrix of values) that includes abstract features or abstract data elements and metadata 129.

As further shown, a system may include a server 130 that may include a server profiling unit (SPU) 135 and a prediction unit (PU) 136. As shown, server 130 may be operatively connected to a server storage system 140. For example, server storage system 140 may be a local, or directly connected, storage system, e.g., an array of hard drive, or server storage system 140 may be a remote or network-based storage system. As shown, a system may include or may be connected to, a 3^{rd} party server 150 and a network 160.

Network 160 may be, may include or may be part of a private or public IP network, or the internet, or a combination thereof. Additionally or alternatively, network 160 may be, include or be part of a global system for mobile communications (GSM) network. For example, network 160 may include an IP network such as the internet, a GSM related network and any equipment for bridging or otherwise connecting such networks as known in the art. In addition, network 150 may be, or may include, a local area network (LAN), a wide area network (WAN), a wireline or wireless network or a cellular communication network. Accordingly, numerous elements of network 160 are implied but not shown, e.g., access points, base stations, communication satellites, GPS satellites, routers, telephone switches, etc. It will be recognized that embodiments of the invention are not limited by the type or nature of network 160. Network 160 may enable user computing device 110, server 130, 3^{rd} party server 150 and, in some case, server storage system 140, to communicate, e.g., send/receive digital information to/from each other.

User computing device 110 may be any personal computer or device or communication device, e.g., a home computer, a laptop computer, tablet computer or a mobile device. For example, in some embodiments, user computing device 110 is a smartphone, a cellular telephone or a mobile phone, as known in the art. Generally, user computing device 110 may be any computing device that stores or includes digital visual content, e.g., digital pictures, images and/or video clips as known in the art.

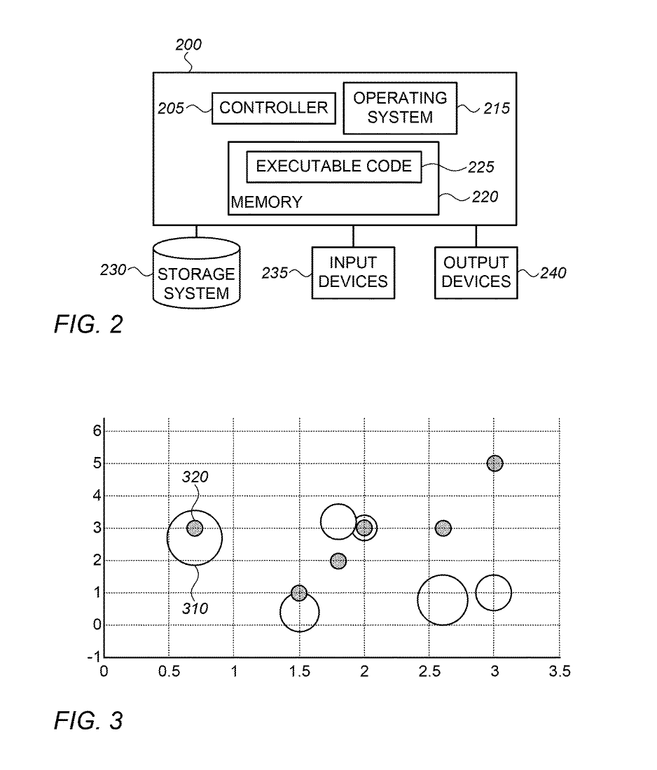

LPU 115 may be any unit or module capable of communicating with server 130 and/or 3^{rd} party server 150. LPU 115 may be adapted to process visual content stored in local storage 125. For example, LPU 115 may be a unit that includes a controller 205, a memory 220 and executable code 225 as described with reference to FIG. 2. LPU 115 may be adapted to receive a query and, using filter sets, models and other data as described, LPU 115 or PU 136 may generate and provide a prediction and/or response to a query.

3^{rd} party unit 120 may be any module provided by any party. For example, 3rd party unit may be an application or plug-in provided by an advertiser, publisher or content provider. In some embodiments, LPU 115 may be, or may include, a software development kit (SDK or “devkit” as known in the art). For example, LPU 115 or parts of LPU 115 may be included in 3rd party unit 120, e.g., downloaded with 3rd party unit 120 as known in the art.

Local storage system 125 may be any suitable storage medium for storing digital or visual content. For example, local storage system 125 may be a local, or directly connected, storage system, e.g., a flash memory, a universal serial bus (USB) device and the like. In some embodiments, local storage system 125 may be a hard disk or any memory or chip suitable for storing images and video clips. It will be understood that LPU 115, 3^{rd} party unit 120 and local storage system 125 may communicate with each other, e.g., using an operating system or other components included in user device 110. For example, LPU 115 may send data to, and receive data from, 3^{rd} party unit 120. Furthermore, LPU 115, 3^{rd} party unit 120 and local storage system 125 may communicate, over network 160, with any device or system connected to network 160. For example, LPU 115 may send data to, and receive data from, server 130. Similarly, 3^{rd} party unit 120 may communicate with 3^{rd} party server 150.

Each of abstract features 126, visual content 127, abstract data elements vector 128 and metadata 129 may be digital information stored in local storage system 125, e.g., in a file or other object as known in the art. In some embodiments, abstract features 126 may be a segment in a memory, e.g., data stored in a segment of a memory 220 as described with reference to FIG. 2. Abstract data elements vector 128 may include some elements in abstract features 126. In some embodiments, abstract features 126 may be, or may include all abstract data collected and calculated based on all visual content found, e.g., by LPU 115, in user computing device 110 and abstract data elements vector 128 may be, or may include, some data elements or portion of abstract features 126.

Metadata 129 may include for example non-image data that is related to or describes visual content. For example, metadata 129 may include any metadata related to visual content and may be, or may include a source of an image or video clip (e.g., taken by the user, received via a social network application, received using a specific messaging application). Metadata 129 may include location or global positioning system (GPS) data associated with an image (e.g., where a picture was taken). Metadata 129 may include a time and/or date an image was created or received etc. Metadata may include other or additional information.

Abstract or summary data when discussed herein may be data that summarizes or abstracts other data, or that shows in a smaller version of place some characteristic of a larger group of data. For example, abstract features 126 and/or abstract data elements vector 128 may include abstract data values such as a frequency of appearance of a feature or object in scanned images, e.g., the percentage or number of images that include an object or scene. For example, if many images in a set or gallery of images stored on a smartphone include a dog then the frequency of a “dog” object, as identified by LPU 115, may be high and LPU 115 may include in abstract features 126 and/or abstract data elements vector 128 a value that indicates a high frequency of the object “dog”.

Abstract features 126 and/or abstract data elements vector 128 may include abstract data such as geo-location or other location information related to the visual content, e.g., the location where a feature or object in an image was captured may be included in abstract data. Abstract features 126 and/or abstract data elements vector 128 may include source information or data.

For example, abstract features 126 or other abstract data may include, e.g., for each feature or object, the locations where it was captured in visual content. Abstract data (e.g., in abstract features 126 and/or abstract data elements vector 128) may associate an object with a location. For example, abstract data may include data that indicates that most of the images that include the object “dog” were captured in the same location. For example, by identifying all images that include a dog and further identifying where these images were taken, LPU 115 may collect or generate abstract data that includes a frequency per location value for an object or feature that indicates the association or correlation of the object or feature with a location.

Abstract features 126 and abstract data as referred to herein may include time, frequency and/or date information related to visual content. For example, by examining visual content and associated metadata, LPU 115 may calculate a value that associates an object or feature with time or frequency. For example, LPU 115 may include in abstract features 126 and/or in abstract data elements vector 128 values that reflect or indicate when an object was captured in images, along a timeline, or LPU 115 may include in abstract features 126 and/or in abstract data elements vector 128 values that reflect or indicate a time (or date) when an image or video of an object was captured, a time range or period in which an object was captured a high (or over a threshold) number of times, the number of times an object was captured during a time period, etc.

Accordingly, a frequency per time value may be calculated and/or included in a set of abstract data, e.g., included in abstract features 126 and/or abstract data elements vector 128. In a similar way, LPU 115 may calculate a frequency per source value or other frequencies as required. Abstract data as referred to herein may include a digital representation of a visual feature, e.g., intensity, saturation and the like, for example a number representing color, hue, saturation or intensity.

Abstract data elements vector 128 may be a set, array, or sequence of abstract data elements or abstract features, e.g., abstract data elements vector 128 may include some of abstract features 126 as described herein. For example, LPU 115 may identify and/or extract abstract data elements from visual content 127 and may store the extracted abstract data elements and data from metadata 129 in abstract data elements vector 128.

Visual content 127 may be images, video clips and the like. For example, visual content 127 may be, or may include images or videos taken or captured by a user when using user computing device 110, images and video content received by user computing device 110 from any source, e.g., from a social network, by electronic mail (email), via an instant messaging application etc.

Server 130 may be any suitable computer, e.g., a server computer as known in the art. SPU 135 may be any unit or module adapted to process visual content. For example, SPU 135 may be a unit that includes a controller 205, a memory 220 and executable code 225 as described with reference to FIG. 2. For example, based on processing that includes extracting visual features from a bank of images, SPU 135 may create or define filter sets or models as described herein. PU 136 may be adapted to receive a query and, using methods and operations as described herein, PU 136 may generate and provide a prediction and/or a response to a query. PU 136 may be a unit that includes a controller 205, a memory 220 and executable code 225 as described with reference to FIG. 2.

Reference is made to FIG. 2, showing a high level block diagram of an exemplary computing device according to some embodiments of the present invention. Computing device 200 may include a controller 205 that may be, for example, a central processing unit processor (CPU), a graphics processing unit (GPU) or a visual processing unit (VPU). Controller 205 may be a chip or any suitable computing or computational unit or component. As shown, computing device 200 may include an operating system 215, a memory 220, an executable code 225, a storage system 230, input devices 235 and output devices 240. Controller 205 may be configured to carry out methods described herein, and/or to execute or act as the various modules, units, etc. More than one computing device 200 may be included, and one or more computing devices 200 may act as the various components, for example the components shown in FIG. 1. For example, each of user computing device 110, LPU 115, 3^{rd} party unit 120, 3^{rd} party server 150, server 130, PU 136 and/or SPU 135 described herein may be, or may include components of, computing device 200. For example, by executing executable code 225 stored in memory 220, controller 205 may be configured to carry out a method of personalizing, categorizing or profiling a user and/or providing a response to a query as described herein. Controller 205 may be configured to generate and provide a prediction as further described herein.

For example, controller 205 may be configured to generate abstract or summary data based on visual features identified in images, video clips or any visual content stored in a computing device operated by a user and generate a prediction related to a user, or a profile of the user, based on the abstract data. In some embodiments, controller 205 may be configured to provide a prediction or a profile (e.g., to a server) and/or respond to a query based on a profile or based on abstract data as described herein.

Operating system 215 may be or may include any code segment (e.g., one similar to executable code 225 described herein) designed and/or configured to perform tasks involving coordination, scheduling, arbitration, supervising, controlling or otherwise managing operation of computing device 200, for example, scheduling execution of software programs or enabling software programs or other modules or units to communicate. Operating system 215 may be for example a commercial operating system.

Memory 220 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 220 may be or may include a plurality of, possibly different memory units. Memory 220 may be a computer or processor non-transitory readable medium, or a computer non-transitory storage medium, e.g., a RAM.

Executable code 225 may be any executable code, e.g., an application, a program, a process, task or script. Executable code 225 may be executed by controller 205 possibly under control of operating system 215. For example, executable code 225 may be an application that uses abstract data generated based on visual content in order to generate a profile or respond to a query as further described herein. Although, for the sake of clarity, a single item of executable code 225 is shown in FIG. 2, a system according to some embodiments of the invention may include a plurality of executable code segments similar to executable code 225 that may be loaded into memory 220 and cause controller 205 to carry out methods described herein. For example, units or modules described herein (e.g., LPU 115 and SPU 135) may be, or may include, controller 205, memory 220 and executable code 225.

Storage system 230 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage system 230 and may be loaded from storage system 230 into memory 220 where it may be processed by controller 205. In some embodiments, some of the components shown in FIG. 2 may be omitted. For example, memory 220 may be a non-volatile memory having the storage capacity of storage system 230. Accordingly, although shown as a separate component, storage system 230 may be embedded or included in memory 220.

Input devices 235 may be or may include a mouse, a keyboard, a touch screen or pad or any suitable input device. It will be recognized that any suitable number of input devices may be operatively connected to computing device 200 as shown by block 235. Output devices 240 may include one or more displays or monitors, speakers and/or any other suitable output devices. It will be recognized that any suitable number of output devices may be operatively connected to computing device 200 as shown by block 240. Any applicable input/output (I/O) devices may be connected to computing device 200 as shown by blocks 235 and 240. For example, a wired or wireless network interface card (NIC), a printer, a universal serial bus (USB) device or external hard drive may be included in input devices 235 and/or output devices 240.

A system according to some embodiments of the invention may include components such as, but not limited to, a plurality of central processing units (CPU) or any other suitable multi-purpose or specific processors or controllers (e.g., controllers similar to controller 205), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 200.

A system and method according to embodiments of the invention enable providing personalized content (e.g., advertisements) based on user's visual content, e.g., photos and videos in a gallery of a smartphone or computer. For example, a system and method according to embodiments of the invention may identify, list or record, objects and scenes in photos and videos and generate a personal model of a user according to, or based on, identified, recorded or extracted features, objects and scenes. Profiling and personalization may be based on metadata associated with visual content, e.g., a time and date a picture was taken, a geographic location (e.g., where a picture was taken) and so on.

For example, an embodiment may examine galleries of photos and/or video clips in devices of users (e.g., smartphones) and extract characterizing visual features of objects and scenes that appear in the photos and videos. For example, characterizing visual features of objects and scenes may be, or may include, abstract features or abstract data elements as described herein.

An embodiment may obtain metadata of the photos and/or video clips and provide the characterizing features (e.g., in the form of a vector of abstract data elements as described) and the metadata to a remote machine and storage (e.g., to serve 130), where abstract data elements and metadata may be processed in order to generate and provide a profile of the user of each of the devices or smartphones. As described, using the abstract data and metadata, a prediction may be generated, e.g., by PU 136 and/or by LPU 115.

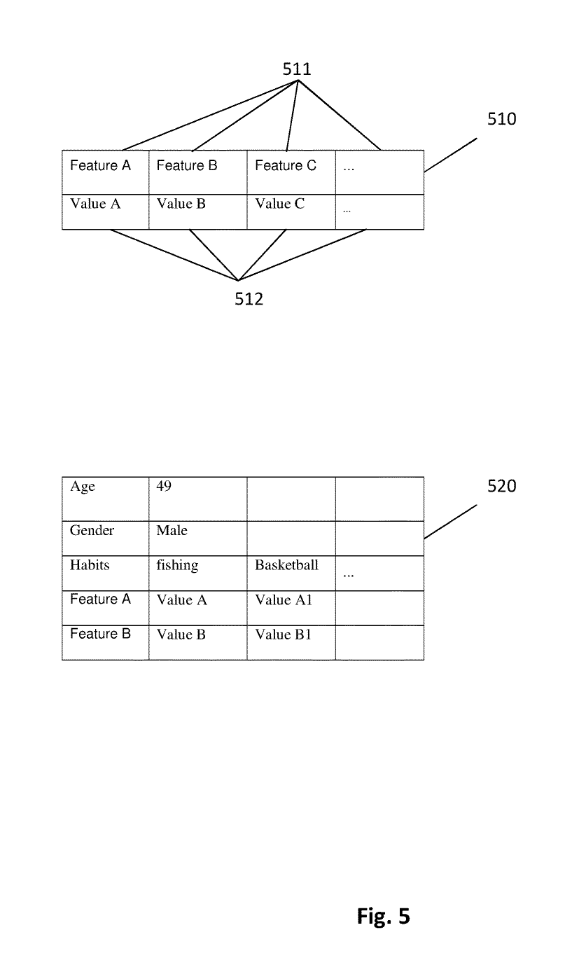

Reference is additionally made to FIG. 5 that schematically and graphically shows an exemplary vector 510 and an exemplary profile 520 according to some embodiments of the invention. Vectors and profiles may be in different formats and may include data other than shown. As shown, vector 510 may include for example abstract data. For example and as shown, vector 510 may include abstract data in the form of a set of features 511 and each of features 511 may be associated with a value 512. For example, feature A may be a dog and value A may be the number or percentage of images, calculated or determined based on all images stored on a user device, that include a dog, feature B may be a scene of a beach and value B may be the number or percentage of images, included in, or calculated with respect to, the set of all user's images, that were taken at the beach and so on. For example, if user computing device 110 (that may be a smartphone) includes or stores 200 images and 10 of those images include a car then feature A may be a car and value A may be “5” or another value that represents 5%.

As shown by profile 520, a profile may include any information characterizing or describing a user, e.g., age, gender, habits and so on. As shown, a profile, e.g., profile 520, may include for example a vector or abstract data as described herein or it may include selected abstract data elements and/or values. For example, profile 520 may include values of abstract data that may be selected from, or may be a subset of, fields and values of a vector produced for a use e.g., a vector as shown by vector 510. For example, the frequency of images of a dog may be included in profile 510 (e.g., as shown by feature A and value A respectively).

A profile may include for example data describing a user. A profile may include many characterizing elements, e.g., habits, preferred locations for after-work retreat, preferred locations abroad, favorite sports, shopping habits and the like. For example, based on a set of abstract data (e.g., as included in abstract features 126 and/or abstract data elements vector 128 as described herein), LPU 115, SPU 135 and/or PU 136 may define, create or generate a user profile. For example, based on the frequency of appearance of the same three children and same dog in images of the user, taken at a location identified as “home”, a user profile may include data that indicates, or reflects, that the user has a dog and has three children. A location may be identified as “home” based on abstract data and/or metadata. For example, if most of the indoor scenes in images of the user are in images taken at the same place, the place may be identified, e.g., by LPU 115 or SPU 135, as the home of the user. As described, a scene may be a feature that may be recognized, e.g., by LPU 115, using a model provided by SPU 135. Other locations, e.g., work place, favorite location for vacations and so on may be identified the way a home is identified.

A profile of a user may be created or updated based on a set of same or identical objects or features identified in images of the user. For example, if the same exact person, dog, car or other object, element or feature are detected in a (possibly larger than a threshold) number of images of the user then the user's profile may be updated accordingly, e.g., a profile may be updated to reflect that the user is in a relationship (or is married) if the same companion person appears in a large number (e.g. over a threshold, over a threshold percentage) of images that also include the user.

A profile of a user may be created or updated based on a set of different objects or features of a same type that are identified in images of the user. For example, if a male user appears with a different woman, in a large set of images taken over a long period of time (e.g., months) then the user's profile may be updated to indicate the user is single and so on. Any heuristics may be applied to features, objects, scenes or other aspects identified in images of a user in order to update a profile of a user.

In some embodiments, SPU 135 may examine a bank of images, videos or any other visual content (e.g., webpages, digital presentations etc.) and generate a model usable for identifying, extracting and/or recording visual features in visual content. Visual features detected, identified and/or recorded or stored as described herein may be, or may be related to, any data or content in visual content. For example, a feature detected by a system or method according to embodiments of the invention may be an object seen in an image (e.g., a shoe, a car or a wheel) or it may be an action or gesture (e.g., running, sleeping, smiling). A feature detected in an image may be a scene, e.g., an indoor scene such as classroom or living room, or a scenic or outdoor scene.

Generally, any aspect that can be recorded by a camera may be defined and identified as a feature. Accordingly, using a proper model, any object, scene, event, circumstance or aspect that can be recorded by a camera or stored in an image may be identified, e.g., by identifying, in an image, a visual feature that is known to represent (or be otherwise associated with) the object, scene, event, circumstance or aspect.

A model created, defined and/or provided by SPU 135 may include a set of filters usable for extracting or identifying a set of visual features from visual content. For example, as known in the art, using labeled data, a filter may be trained or generated such that specific visual features in an image are identified. As known in the art, a filter may include logic and/or data that may be used in order to identify a feature in an image, e.g., identify colors, objects scenes and the like based on digital information. For example, and as known in the art, a filter may be used in order to analyze values of pixels that represent an image and thus identify features in the image. A filter as referred to herein may be or may include any logic or data (e.g. executable by controller 2015) usable for processing digital images and identifying or extracting features therefrom. For example, if the top portion of an image includes blue color and the bottom or lower portion includes brown colors (e.g., colors may be determined based on pixel values as known in the art) then logic in a filter may determine that the image was taken outdoors. SPU 135 may generate or create a model that can be used to identify any number of different visual features, objects or scenes in images. For example, a model generated and provided (e.g., to LPU 115) by SPU 135 may be used in order to identify any visual feature or object in an image (e.g., a dog, a smile or a mountain). A model created or defined by SPU 135 may be used in order to identify any scene in, or of, an image (e.g., a beach, a living room etc.).

LPU 115 may be provided with a model. For example, a model created by SPU 135 as described may be provided to LPU 115 (e.g., over network 160). Using a model, LPU 115 may identify, extract and/or record, visual features in visual content stored in a computing device operated by a user. For example, LPU 115 may analyze or examine images in an image gallery stored in a memory of a mobile phone of a user, identify visual features in the images and generate abstract data based on the identified visual features.

In some embodiments, a probability that a feature is present in visual content may be calculated. An identification of a feature in an image or determination that a feature exists, or is shown in the image may be based on a probability as described. For example, LPU 115 may, based on examining an image, determine that a feature such as a cat is included in the image with a probability of 0.87. Calculating a probability for a given set of features is known in the art of image processing (e.g., as in the Markov random fields (MRF) technique). A system and method according to some embodiments of the invention may use any system or method for calculating a probability (e.g., in the range of 0-1) that a feature, or a set of features, exists or appears in an image.

A probability threshold may be used in order to determine whether or not a feature is included in an image. For example, if a probability threshold is set to 0.85, then, if the probability that a dog appears in an image is 0.68, LPU 115 may determine (and/or treat the image as if) the image does not include a dog. Using the above probability threshold, if the probability that a dog appears in the image, e.g., as calculated by LPU 115, is 0.92, then LPU 115 may determine (and/or treat the image as if) the image includes a dog. Different probability thresholds may be set for different features. For example, the threshold for a cat may be different than the threshold of a mountain.

Any number of probabilities may be calculated for an image and a decision, determination or identification of features, e.g., objects and scenes, included or shown in the image may be based on any logic involving any number of probabilities related to the image.

For example, a probability that the scene in an image is of a beach may be calculated by LPU 115 to be 0.46 and the probability that the scene in an image is of a party may be 0.72, in such case, based on relating or comparing a first and second probabilities, LPU 115 may determine the scene in the image is of a party.

Techniques and image recognition methods other than probability thresholds and MRF techniques may be used to recognize or identify features in images.

According to some embodiments of the invention, a model may be dynamically updated by a server. For example, LPU 115 may periodically, when first executed after a reset, or based on an event, check whether or not a model stored in user computing device 110 needs to be updated and, if so, a new or updated model may be downloaded from server 130.

According to some embodiments of the invention, a size of a model may be reduced for example by a server. For example, in order to save storage space on user computing device 110, the size of a model sent or downloaded from server 130 to user computing device 110 may be reduced by quantization of weights in a kernel of a filter matrix. In some embodiments, a model may include one or more filter matrices implemented using a kernel as known in the art. As known in the art, quantization of weights in a kernel may include removing or merging some of the weights in a kernel thus reducing the size of the kernel.

Reducing a size of a model may include zeroing (e.g., setting to zero, although setting to values other than zero may be used) of selected values in a kernel of a filter matrix in a model. For example, a threshold may be automatically or empirically defined and weights in a kernel having values that are smaller than the threshold may be removed from the kernel thus effectively reducing the size of the kernel.

Any system or method known in the art may be used in order to reduce a size of a model. For example, the known in the art sparse technique may be used to store and send weights in a kernel of a model or other parameters or values of a model.

LPU 115 may generate a profile of a user based on the abstract data and based on for example metadata related to the visual content. For example, metadata related to visual content may be a digital representation of visual features identified in the visual content (e.g., a set of pixels representing a portion of an image). In some embodiments, metadata may include a frequency of appearance of a visual feature in the visual content, e.g., the percentage or number of images in a gallery that include a cat. In some embodiments, metadata may include geo-location or other location information related to the visual content, for example, data associated with an image by a global positioning system (GPS) component in a smartphone may be used as metadata of the image. In some embodiments, metadata may include time and date information, for example, a name of a file that includes an image stored in a smartphone may include, in textual form, the time and date the image was taken. Accordingly, some embodiments of the invention may use the time and date as recorded in the file name in order to determine time and date information and include the information in metadata of the image. In other cases, some embodiments of the invention may use a time and date stamp in the image itself (e.g., graphically included in the image by a smartphone as known in the art).

In some embodiments, metadata may include information related to a source of a visual content. For example, the source of an image in a gallery of a user may be an application that supports sharing images (e.g., the Facebook™ or WhatsApp™ media platforms), or the source may be a website from which the image was downloaded, or the source may be the local camera, e.g., if the image was taken by a camera included in a user's smartphone or mobile phone.

A user profile generated, e.g., by LPU 115 as described, based on the abstract data and/or based on metadata as described may include various aspects of the user. For example, LPU 115 may include logic that may determine, and include in a profile, information such as an age, gender and/or address of the user. For example, a gender may be identified based on a high percentage of images that contain content known to be more popular with females than with males, an age may be determined or identified based on a frequency of appearance of other content. An address may be determined or identified, e.g., by LPU 115, based on a percentage of images in the same location and further based on the content in those images, e.g., based on a large portion of pictures, all taken at a specific, same location, and including the same three children and dog, by LPU 115 determine that the user is an adult who has three children and a dog and lives at the specific location.

A profile generated, e.g., by LPU 115, on a user device, may be used in a number of ways. For example, LPU 115 may provide the profile to server 130 where the profile may be used as further described herein. LPU 115, or any other unit or entity, may provide the profile, or portions thereof, to a 3^{rd} party that may use the profile as known in the art, e.g., in order to select content to be provided to the user. For example, LPU 115 may inform a 3^{rd} party that the user is an adult female who has three cats. A profile generated as described may be used in order to respond to a query. For example, LPU 115 may receive a query that includes a question such as: “is user a male?”, “is user an adult?”, “does user live in New York City?” and, based on demographic or other data in a profile, LPU 115 may respond to the query, e.g., with a “Yes” or “No” indication or otherwise. Of course, much more complex queries than the above exemplary and simplified queries may be handled by LPU 115, for example, a query may be “is user a female with children and a pet?” and LPU 115 may respond to the query based on the profile as described.

According to some embodiments, abstract data generated based on, or collected from, visual content, may be stored in a vector of abstract data elements, and the vector may be sent to a server. For example, LPU 115 may store some of the abstract data in an array of variables, values or parameters to generate a vector and send the vector to SPU 135 on server 130. For example, a vector sent from LPU 115 to SPU 135 may include identifiers of features detected in images on user computing device 110 and any metadata related to the features. A vector sent from a user device (e.g., user computing device 110) to a server (e.g., server 130) may include all features identified or detected in images on the user device and their respective metadata, or it may include a sub-set thereof. For example, in some embodiments, a vector may only include the top most, or most popular, features or elements in the set of pictures examined. In some embodiments, a vector may include information related to specific aspects, or specific features. For example, a vector may include values of a specific set of predefined features, e.g., a vector may only include features related to, or usable to determine, age and gender and may not include features related to time and location.

A vector of abstract data elements received by a server may be used, e.g., by a server, to respond to a received query. For example, server 130 (or SPU 135) may generate a response to a query received from 3^{rd} party server 150 by relating a vector received from LPU 115 as described to a reference vector. While vectors are described as one data structure used herein, other data structures or formats may be used to hold data.

A reference vector may be generated, e.g., by SPU 135, based on extracting visual features from visual content of a plurality of users. For example, SPU 135 may receive a plurality of vectors from a plurality of LPU's 115 in a plurality of user computing devices 110 and may generate a reference vector based on the plurality of received vectors. For example, vectors from a set of known or classified users may be used in order to generate a reference vector (or signature) of the known or classified users. For example, using a frequency as described, the most popular visual features found in a set of vectors of a set of classified users may be used to generate a reference vector.

A system and method according to some embodiments of the invention may classify a user based on relating a vector generated for the user to a plurality of vectors related to a respective plurality of users. A reference vector may be used in order to determine whether or not a new user belongs to the class of classified users. In some embodiments, if a vector received from LPU 115 as described matches a reference vector of a class of users, then SPU 135 may determine that the user belongs to the class. For example, if a reference vector of a class of users includes information indicating that users in the class have a pet and a received or input user vector does not indicate that the user has a pet, then SPU 135 may determine that the user does not belong to the class. In another exemplary case, if the reference vector is of a class of users who all have children, and the received or input user vector is of a user who has children, then SPU 135 may determine that the user belongs to the class. A response to a query may be based on a classification of a user. For example, a response to a query may be positive (e.g., “1” or “yes, the user is likely to buy a specific product”) if the user belongs to a specific class, or the response may be negative (e.g., “0” or “no, the user is unlikely to buy a specific product”) if the user does not belong to a specified class.

In some embodiments, 3^{rd} party unit 120, when executed on user computing device 110, may generate a first query and may send the first query to a computer associated with the 3^{rd} party, e.g., to 3^{rd} party server 150. The 3^{rd} party server (e.g., 3^{rd} party server 150) may use the first query in order to generate a second query and may send the second query to server 130. Server 130 may respond to the second query and, based on the response, the 3^{rd} party server may cause 3^{rd} party unit 120 to perform an action or a selection, e.g., select content to present to a user of user computing device 110 and present the selected content.

A query sent from 3^{rd} party unit 120 to 3^{rd} party server 150 may be any query as defined by the 3^{rd} party who may control and/or configure 3^{rd} party unit 120 and 3^{rd} party server 150. For example, 3^{rd} party unit 120 may ask, in the first query, whether or not a specific content object (e.g., an advertisement or a message) should be presented to a user of computing device 110. In another case, 3^{rd} party unit 120 may ask, in the first query, whether or not the user belongs to a class or category of users. 3^{rd} party server 150 may be configured to examine a first query received from 3^{rd} party unit 120 and, based on the first query, generate a second or new query. For example, 3^{rd} party server 150 may be configured to interface or interact with server 130, e.g., 3^{rd} party server 150 may be provided with the set of queries supported by server 130, a protocol supported by server 130 and so on.

A system and method according to some embodiments of the invention may predict an action of a user. For example, based on a set of known or characterized users, a vector that includes abstract data related to visual features may be generated such that the vector characterizes the set of known or characterized users. For example, a set of known or characterized users may be a set of existing customers or clients of a service provider or other seller (e.g. a service provided by server 130), for example, a seller may know for some or all the known or characterized their gender, age, address and/or various other demographic or other details users (e.g., in the case that the known or characterized are registered customers or clients of the seller). In some cases, known or characterized users may be users that bought a specific product and/or provided input regarding a specific product or service. For example, a set of known users may be a set of existing customers who all liked a specific product, all bought the same product etc. Accordingly, in order to determine whether or not a new user is likely to buy a specific product or be interested in specific content, a vector or profile of the new user may be compared to a vectors of known or characterized users, e.g., to vectors of a set of known or characterized users who bought the specific product or who showed interest in the specific content, and, if a match between the new user's vector and vectors of the known or characterized users is found then an embodiment may determine or predict that the user is likely to buy the specific product or take interest in the specific content.

For example, by analyzing visual content of some or all of the known or characterized users, and storing data such as: the features identified, the frequency of appearance of features and so on, a vector characterizing the set of known or characterized users may be generated. In order to predict whether or not a user who is new, or yet unknown to an embodiment, is likely to make a selection that is similar to a selection of the majority of the known or characterized users, an embodiment may compare or otherwise relate a vector generated for the new user to the vector that characterizes the group of known users. If the vector of the new user matches the vector of the group, a prediction may be made by a system or method that the user is likely to make a selection that is similar to a selection of the majority of the known or characterized users. For example, if the vectors match as described and a majority of the known users selected to buy a specific product, then a system (e.g., SPU 135 or LPU 115) may determine (and indicate) that the new user is likely to buy the product. Similarly, if the vectors of features of the new user and the group or set of known users do not match, then an embodiment may determine and indicate that the user is unlikely to buy the product.

Any categories or features may be identified or detected by analyzing images, videos or other visual content in a user's device. For example, using a model and filters provided by SPU 135, LPU 115 may examine images and videos in a smartphone and identify therein features such as, pets (e.g., a dog or cat) hobby related elements such as a musical instrument, boat, museum, restaurants, beaches, tracks, bars, etc. Other categories that may be identified or deduced may be food types (e.g., Chinese food or hamburgers, meat or vegetables) or demographic or personal information such as age, gender, household income, marital status, presence of children in the household, home value or type, geographic region, education level, car types, family size, occupation, industry type and a geographic region.

Reference is now made to FIG. 3, an exemplary screenshot that graphically illustrates extraction of features, objects and scenes from visual content and analysis, processing and/or automated understanding of extracted features, objects and scenes, according to one embodiment. In FIG. 3, the white circles 310 represent detections of a certain category or feature. The sizes of the white circles may represent the amount of times each feature, object or scene is detected in a set of images or visual content objects. In some embodiments, a size or weight of an object or feature may be set based on a source of images that include the object or feature. For example, a weight of an object captured by a local camera may be set higher than that of an object found in an image received by mail or by a messaging application. For example, based on where images are stored in user computing device 110 (e.g., a folder), SPU 115 may determine the source of the images. Accordingly, a source of a visual object may be known and used as described. In some embodiments, a user dashboard or other interface may present information related to users as shown in FIG. 3. For example, by projecting data on a graph or display of a server (e.g., a display connected to server 130), a system and method according to some embodiments of the invention may graphically present various aspects of users as exemplified by FIG. 3.

The black circles 320 in FIG. 3 represent geo-location information. For example and as described, the location where a picture or video clip were taken may be known, e.g., using metadata stored by a camera or a GPS component in a smartphone. Analysis of a feature vector that includes information as graphically illustrated in FIG. 3, e.g., analysis and logic executed by SPU 135 with respect to a vector received from LPU 115, may enable identifying or classifying a user.

For example, circle 310 in FIG. 3 may be or may represent detection of a dog, and the size of circle 310 may indicate or represent that 50 images in user computing device 110 included the same dog. Circle 320 may represent geo-location information of the feature (e.g., the dog). For example, circle 320 may represent the home of the user where most of the pictures of the user's dog were taken.

For example, in the exemplary case illustrated by FIG. 3, SPU 135 may determine that the user is a dog owner, e.g., by calculating the amount or percentage of images of the same dog in the ‘home’ geo location. A location of a home of a user may be determined automatically. For example, the location where most of the pictures of at least one of: an indoor scene, a pet or children may be determined as the home or address of the user.

It will be understood that FIG. 3 illustrates a simplified and exemplary case and that complex features and metadata may be collected as described and stored in a vector or profile of a user. By relating a vector or profile of a user to a reference vector and metadata (e.g., a vector of a set of known or characterized users), an embodiment may predict user actions or preferences and/or may select content for presentation to a user.

For example, PU 136 may obtain profiles, possibly in the form of vectors (although other forms may be used), of a known set of users. For example, in order to predict whether or not a user will like a specific product, a profile (or vector) of the user may be related or compared to a plurality of profiles or vectors (e.g., vectors such as abstract data elements vector 128) of a respective plurality of users known to have bought the specific product. Based on relating the profiles or vectors, PU 136 may predict, or generate and provide a prediction. For example, if a vector 128 of the user is close to the vectors of the known users, PU 136 may predict that the user will buy the product, otherwise, PU 136 may predict the user is unlikely to buy the product.

A system and method according to some embodiments may generate a prediction based on abstract data of a user (or user abstract data) and abstract data of a set of known or classified users. For example, a set of visual features in visual content of a plurality of known users may be identified and abstract data for the plurality of known users may be stored, e.g., in a file on server storage system 140. Abstract data of a plurality of known users may be referred to herein as class abstract data. For example, using labeled data as known in the art, SPU 135 may generate a set of class abstract data for customers of a network carrier or user who often visit a website.

A prediction may be in the form of a “Yes” or “No” value or a “Positive” or “Negative” indication with respect to a question or query. For example, a question may be, or may include “Will the user buy this car?”, “Will the user click on this banner?”, etc. A prediction may be an indication or estimation of whether or not a user will perform an action, e.g., a prediction may inform whether or not a user is likely to click on a specific advertisement. A prediction may include, or be related to, a behavior of a user, e.g., “will the user call an advertised telephone number?” For example and as known in the art, using labeled data, a hyperplane that separates users into two categories or classes with respect to a feature may be defined. Accordingly, in order to generate a prediction for a user, PU 136 may project a vector of the user on a space defined by a set of abstract data elements and classify the user (e.g., based on distance from a hyperplane or otherwise as known in the art). Having classified a user, PU 136 may determine whether or not the user belongs to the same class of a known or classified set of users. If the user belongs to the class, PU 136 may predict (and generate a prediction that) the user will behave or act in a way similar to the way the set of users does or did.

PU 136 may generate a prediction for a user based on relating the user's abstract data to abstract data of a class of users (class abstract data). For example, if PU 136 determines that the user belongs to the class of users and if the user all clicked on a specific banner shown in a web browser, then PU 136 may predict the user will click on the banner. It will be understood that classification as described herein is only one example of generating a prediction. PU 136 may use various other methods of analyzing, relating or comparing abstract data of a user in order to generate a prediction. For example, SPU 135 may identify two groups or classes of users, e.g., a first group or class that did not click on a banner and a second group or class that did click on the banner and SPU 135 may provide abstract data for the two groups or classes. PU 136 may relate or compare abstract data of a user to the abstract data of the two groups or classes and, based on a match of the user's abstract data with each of the abstract data of the two groups, generate a prediction. For example, if the abstract data of the user matches the abstract data of the class or group that did not click on a banner, PU 136 may predict (and inform or indicate) that the user will not click on the banner.

As described, in some embodiments, a prediction may be binary or boolean as known in the art, e.g., a data type or value that can have only one of two possible values, for example, either “Yes” or “No” or either “0” or “1”. However, in some embodiments, a prediction may be, or may include additional or other values or data types. For example, given a set of advertisement that can potentially be presented to a user, a prediction made by PU 136 may include a respective set of probabilities, or matching scores, that indicate or represent the likelihood that the user will respond to the advertisements. For example, an advertiser may have a set of advertisements or messages intended for users. Rather than randomly presenting a set of advertisements, e.g., randomly select one of the advertisements in the set to be sent to a user, an advertiser may send a query that generally includes the question “which of the attached set of advertisements is the user most likely to respond to?”. For example, the set of advertisements and an identification of the user may be included in a query. PU 136 may receive a query as in the above example and provide, for each of the advertisements, a matching or likelihood value. For example, given a set of advertisements and a user, PU 136 may predict that the user will respond to a first advertisement in the set with a probability of 0.67 and that the user will respond to a second advertisement in the set with a probability of 0.87. A probability may be calculated based on a vector of abstract data elements of a user and relating user abstract data to abstract data of a set of users as and/or based on labeled data as described.

A prediction may include a selection. For example, in the above example, PU 136 may select the advertisement for which PU 136 calculated or determined the highest probability. Accordingly, a system and method according to some embodiments of the invention may automatically select content to be provided to a user based on user abstract data collected from and generated based on, visual content of the user.

Relating or comparing vectors (e.g., comparing a user or input vector to a reference vector as described) may include defining and using a space of interest. Otherwise described, relating or comparing vectors may include relating or comparing the projections of the vectors on a predefined space.

For example, assuming the reference vector is created based on a set of users who have a dog, e.g., the set of users are all happy and loyal customers of a business that sells dog food or a dog frequently appears in picture stored on their smartphones. Assuming further that the dog food business wants to know if a new or yet unknown user is likely to buy dog food. In such exemplary case, a system and method according to some embodiments of the invention may use the values of dog and its frequency in the reference vector and the vector of the new user (also referred to herein as “input vector”) in order to define two vectors in a space, where the axes of the space are “dog” and its “frequency in images of the user” as described. Otherwise described, the two defined vectors are the projections of the reference vector and the new user's vector on the space defined by “dog” and its “frequency”. The defined vectors (or the projections) may be evaluated, related or compared, e.g., their distance may be compared to a threshold or predefined value and an indication of a match or mismatch may be generated based on the distance.

It will be understood that a space of any dimension may be defined and, accordingly, that vectors of any dimension may be compared or matched. For example, a space defined by gender, age and home address (or projections of vectors on such space) may be used.

Matching of vectors may generally include determining or quantifying the distance between vectors. A distance between vectors may be calculated or determined as known in the art, e.g., by determining the Euclidean distance between points on the vectors. For example, a distance between vectors may be defined or determined based on the shortest line that connects the two vectors, by the distance between the ends of the vectors and the like. A match between vectors may be determined based on a distance between the vectors. For example, if two vectors are close to one another, coincide or are generally the same then an embodiment may determine the vectors match, if two vectors are distant from one another or are otherwise different then an embodiment may determine the vectors do not match (e.g., identify a mismatch). For example, if two compared vectors coincide or are otherwise identical, then the vectors may be considered as matching. In some embodiments, a distance threshold may be defined and if the distance between two compared vectors is less than the threshold, the vectors may be considered as matching, e.g., SPU 135 may declare or indicate the vectors match. Other ways of matching vectors may be used.

A system or method according to some embodiments of the invention may create, store and use any number of reference vectors. For example, using images of individuals who are known to be males, a male-reference-vector, usable for determining whether or not a user is a male may be created. For example, a vector of a new user, or any input vector of an unknown user, may be compared or matched with the male-reference-vector and an indication of whether or not the input vector is of a male may be generated based on the distance of the male-reference-vector and the input vector, when projected on a predefined space.

As described, the space used for comparing vectors may be defined, e.g., SPU 135 may receive a definition of a space to use when comparing vectors. For example, the space used may be defined based on input from a client, e.g., a set of objectives or a set of features of interest. A threshold used for determining whether or not two vectors are close may be based on input, e.g., from a client. For example, a certainty or confidence level of a matching process may be raised or lowered by increasing or decreasing a threshold used by SPU 135 as described.

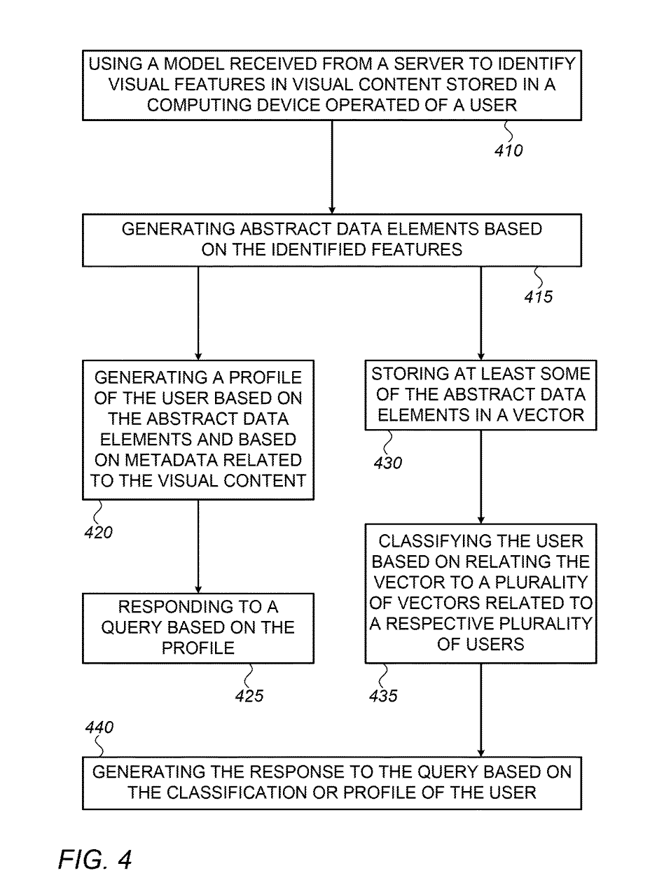

Reference is made to FIG. 4, a flowchart of a method according to illustrative embodiments of the present invention. While in one embodiment hardware and devices such as shown in FIGS. 1 and 2 can be used to execute operations shown in FIG. 4, in other embodiments other hardware and devices may be used. As shown by block 410, a model may be received from a server and the model may be used to identify visual features in visual content stored in a computing device operated by a user. For example, LPU 115 may receive a model from server 130 and use the model to identify visual features in images and videos on a smartphone or mobile device. As shown by block 415, abstract data may be generated based on the identified features. For example, metadata such as frequency, location and time for each identified feature or object may be generated, e.g., by LPU 115 as described.

As shown by block 420, a profile of a user may be generated based on the abstract data and based on metadata related to the visual content. For example, abstract data and metadata may be sent from LPU 115 to SPU 135 and may be used by SPU 135 to generate a profile of a user, as described. As shown by block 425, a response to a query may be generated based on the profile. For example, a profile of a user may include a vector generated by, and sent from, LPU 115 and a response to a query (e.g., “will the user buy dog food?”) may be generated based on the profile or vector, e.g., by relating the vector received from LPU 115 to a reference vector as described.

In some embodiments, LPU 115 may respond to a query as described. For example, LPU 115 may perform the operations shown in blocks 410, 415, 420 and 425 thus LPU 115 may provide a response to a query and/or provide a prediction. In some embodiments, LPU 115, SPU 135 and/or PU 136 may collaborate, e.g., in order to provide a response or prediction. For example, classifying a user based on relating a vector or profile of the user to a plurality of vectors or profiles of known or labeled users, and generating a response based on the relation may be done by PU 136 or by SPU 135 on server 130. Accordingly, an embodiment may use a client server paradigm such that operations requiring substantial computational resources are performed on a server and resources on a user device are minimally used. For example, the operations shown by blocks 435 and 440 may be performed on a server, e.g., by PU 136 or SPU 135 as described.

As shown by block 430, at least some of the abstract data may be stored in a vector. Other data storage formats or structures may be used. For example, LPU 115 may store abstract data in a vector as described. As shown by block 435, the user may be classified by relating the vector to a plurality of vectors related to a respective plurality of users. For example, by determining whether or not a vector of a user is close to a vector (or set of vectors) of a plurality of known users, SPU 135 may determine whether or not the user belongs to the class of the plurality of users. As described, a class of users may be defined by a set of features or objects and their metadata, e.g., time, location and frequency data related to objects, scenes and features as described. As shown by block 440, a response may be generated based on a classification of a user. For example, SPU 135 may determine that a user belongs to an indicated, or reference, class of users, e.g., by comparing a vector of the user to vectors of users in the class, and may generate a response accordingly, as described.

As described, embodiments of the invention are inextricably tied to computer technology, for example, analyzing visual content as described (e.g., analyzing pixel values of pixels that represent a digital image) are operations that can only be done by a computing device. Embodiments of the invention improve the technology of profiling users. For example, by profiling a user based on visual content stored in the user's device, embodiments of the invention enable and provide advantages and improvements, e.g., accuracy of the resulting profile (for example, since the visual content may be specific to the user). Other improvements may be the speed with which the profiling is done, for example, by analyzing images on the user's device, images may be analyzed immediately after they are acquired by the user. Yet another improvement may be related to the distributed nature of embodiments, for example, rather than analyzing visual content by a server as done by some known systems and methods, embodiments of the invention may distribute the processing efforts, e.g., by performing the required processing on users' devices and not by a centralized server. Generally, in contrast to a system and method that uses a centralized server for profiling a plurality of users, embodiments of the invention distribute the processing required for profiling a plurality of users by offloading the processing to users' devices thus the processing is distributed and note centralized. For example, using a centralized server for profiling users yields a system that is not readily scalable, e.g., in order to enable profiling a growing number of users, additional servers are required, in contrast, an embodiment may be highly scalable since increasing the number of users also increases processing power of a system as each additional user also adds, to a system, the processing power of his or her computing device.

As described, embodiments of the invention address a challenges faced by the industry, e.g., the challenge of profiling users for various purposes is addressed by some embodiments that may provide accurate, fast and distributed profiling of users.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method comprising:
generating a set of abstract data based on features identified in visual content, the visual content stored in a computing device of a user, wherein the visual content includes at least one of: digital images and digital video content;
obtaining metadata related to the visual content; and
generating a profile of the user based on values included in the set of abstract data and based on the metadata.

2. The method of claim 1, further comprising using the profile to perform at least one of: generating a prediction related to a behavior of the user and selecting content to be presented to the user.

3. The method of claim 1, further comprising responding to a query based on at least one of: the profile, the abstract data and the metadata.

4. The method of claim 1, further comprising responding to a query based on relating the profile to a plurality of profiles of known users.

5. The method of claim 1, further comprising predicting, based on the profile, whether or not a user will positively respond to a presentation of a specific content.

6. The method of claim 1, wherein generating the abstract data is based on a model received from a server wherein the model is dynamically updated by the server

7. The method of claim 1, wherein the generated abstract data includes at least one of: a digital representation of visual features identified in the visual content, a frequency of appearance of a visual feature in the visual content, geo-location information related to the visual content, time information, and information related to a source of a visual content.

8. The method of claim 1, further comprising:
classifying the user based on relating the profile of the user to a plurality of profiles of known users; and
generating a response to a query based on the classification of the user.

9. The method of claim 1, further comprising:
generating a first query by a 3^{rd} party module executed on the computing device, and sending the first query to a computer associated with the 3^{rd} party;
generating by the computer, and based on the first query, a second query, and sending the second query to a server;
receiving, by the computer, a response to the second query from the server; and
based on the response, causing the 3^{rd} party module to perform an action by sending a message from the computer to the 3^{rd} party module.

10. The method of claim 6, wherein the model includes a set of filters usable for extracting visual features from the visual content.

11. A computer-implemented method comprising:
identifying visual features in visual content of a user and generating user abstract data based on the identified features;
generating a vector based on the abstract data; and
using the vector to classify the user.

12. A system comprising:
a memory; and
a controller configured to:
generate abstract data based on features identified in visual content, the visual content stored in a computing device of a user; and
generate a profile of the user based on the abstract data and based on metadata related to the visual content.

13. The system of claim 12, wherein the controller is configured to use the profile to perform at least one of: generating a prediction related to a behavior of the user and selecting content to be presented to the user.

14. The system of claim 12, wherein the controller is configured to respond to a query based on at least one of: the profile, the abstract data and the metadata.

15. The system of claim 12, wherein the controller is configured to respond to a query based on relating the profile to a plurality of profiles of known users.

16. The system of claim 12, wherein the controller is configured to predict, based on the profile, whether or not a user will positively respond to a presentation of a specific content.

17. The system of claim 12, wherein the controller is configured to generate the abstract data is based on a model received from a server wherein the model is dynamically updated by the server

18. The system of claim 12, wherein the generated abstract data includes at least one of: a digital representation of visual features identified in the visual content, a frequency of appearance of a visual feature in the visual content, geo-location information related to the visual content, time information, and information related to a source of a visual content.

19. The system of claim 12, wherein the controller is configured to:
classify the user based on relating the profile of the user to a plurality of profiles of known users; and
generate a response to a query based on the classification of the user.

20. The system of claim 12, wherein the model includes a set of filters usable for extracting visual features from the visual content.
